(19) United States
(12) Patent Application Publication
(10) Pub. No.: US 2014/0124556 A1
(43) Pub. Date: May 8, 2014

(54) Mobile Electronic Device Holder

(71) Applicant: Peigen Jiang, Sammamish, WA (US)

(72) Inventor: Peigen Jiang, Sammamish, WA (US)

(21) Appl. No.: 13/669,458

(22) Filed: Nov. 6, 2012

(51) Int. Cl. B60R 11/00

(52) U.S. Cl. CPC B60R 11/00
USPC 224/559; 248/205.5; 248/206.2; 248/205.8

(57) ABSTRACT

A holder for mounting a mobile electronic device to a vehicle is disclosed which comprises a first suction device for being mounted to a smooth surface in the vehicle by a suction force, a second suction device for being mounted to a smooth surface on the mobile electronic device also by a suction force, and a linking member having a first end attached to the first suction device and a second end attached to the second suction device.

### CROSS-REFERENCE

This application is a continuation-in-part of U.S. patent application Ser. No. 13/654,427, titled “MOBILE DEVICE HOLDER”, filed on Oct. 18, 2012, which is fully incorporated by reference herein.

### BACKGROUND

The present invention relates generally to mobile device holders, and, more particularly, to cell phone holders for automobiles.

Portable communication devices, particularly mobile phones built on a mobile operating system, or Smartphones, that have advanced computing capability and connectivity, are gaining popularity. Most Smartphones have built-in global positioning system (GPS), and are often used in automobile to provide driving directions. An advantage of using the Smartphone's GPS is that the Smartphone can access the latest map information over a wireless communication network. Another advantage is that a Smartphone always travels with its owner, so that his/her GPS accessibility is not limited to a particular automobile. However, in order to use a Smartphone in an automobile, the Smartphone needs to be mounted in a location in the proximity of the automobile driver. Most existing Smartphone holder are designed for one or a few types of Smartphones and are often quite bulky and not easy to be carried around.

As such, what is desired is a sleek mobile device holder for use in automobiles that can hold different types of mobile electronic devices.

### SUMMARY

The present invention discloses a holder for mounting a mobile electronic device to a vehicle. The holder comprises a first suction device for being mounted to a smooth surface in the vehicle by a suction force, a second suction device for being mounted to a smooth surface on the mobile electronic device also by a suction force, and a linking member having a first end attached to the first suction device and a second end attached to the second suction device.

According to one aspect of the present invention, the linking member is made of a flexible conduit. According to another aspect of the present invention, the first or the second suction device includes a rubber suction cup and a cover cup, wherein the cover cup can press the rubber suction cup against the smooth surface the first or second suction device is mounted thereon.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 illustrates a mobile electronic device holder mounting a Smartphone to a windshield of an automobile according to a first embodiment of the present invention.

FIG. 2 is a cross-sectional view of a first implementation of the suction device for the mobile electronic device holder of FIG. 1.

FIG. 3 is a cross-sectional view of a second implementation of the suction device for the mobile electronic device holder of FIG. 1.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The following will provide a detailed description of a holder for mounting a mobile electronic device, such as a Smartphone, to a windshield of an automobile.

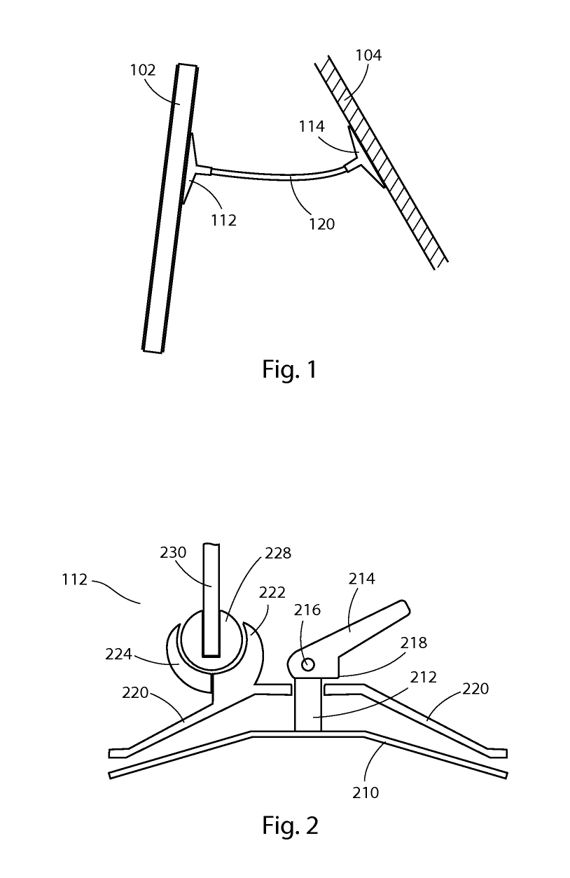

FIG. 1 illustrates a mobile electronic device holder mounting a Smartphone 102 to a windshield 104 of an automobile (not shown) according to a first embodiment of the present invention. The mobile electronic device holder include a first suction device 112 secured to the Smartphone 102 by a suction force, and a second suction device 114 secured to the windshield 104 also by a suction force. The first suction device 112 and the second suction device 114 are linked by a flexible rod 120, which can be bent with a certain amount of force, so that the Smartphone's front plate can be adjusted to face a driver of the automobile. The flexible rod 120 can be formed by a flexible metal or plastic conduit. Because the windshield 104 generally has a large flat area, the second suction device 114 can be larger than the first suction device 112.

FIG. 2 is a cross-sectional view of a first implementation of the first suction device 112 for the mobile device holder of FIG. 1. Referring to FIG. 2, the first suction device 112 includes a suction cup 210 that is conventionally made of a rubber material, and can be pressed against a smooth surface (not shown) to squeeze out air between the suction cup 210 and the smooth surface, so that outside air pressure can hold the suction cup 210 onto the smooth surface.

Referring to FIG. 2 again, the first suction device 112 also includes a cover cup 220 that is made of a rigid material, such as plastic. Conventionally both the suction cup 210 and the cover cup 220 are circular in shape, and FIG. 2 shows a cross-section across the middle of the circle. The cover cup 220 has a peripheral ring that approximately coincides with a peripheral ring of the suction cup 210. When the cover cup 220 is pressed against the suction cup 210, the peripheral ring of the cover cup 220 presses the peripheral ring of the suction cup 210 against the smooth surface, so that air will not leak into the space between the suction cup 210 and the smooth surface. As a result, the suction cup 210 is securely held onto the smooth surface.

Referring to FIG. 2 again, the first suction device 112 also includes a rod 212 that is attached to the suction cup 210, and is conventionally made of a rigid material, such as plastic. In case a plastic material is used, the suction cup 210 and the rod 212 can be molded into one piece so that they are solidly attached to each other. The rod 212 goes through a central opening in the cover cup 220 and is pivotally linked with a handle 214 through a pin 216 that goes through a hole in the rod 212 (not shown) and a hole in the handle 214. The handle 214 is specially contoured to have a protruding member 218, when the handle 214 is pressed and rotates downward, the protruding member 218 urges the cover cup 220 against the suction cup 210. In this position, the first suction device 112 is securely mounted on the smooth surface. When the handle 214 is lifted and rotates upward, the protruding member 218 rotates away from the cover cup 220, so that there will be a gap between the cover cup 220 and the suction cup 210. In this position, the first suction device 112 can be easily removed from the smooth surface by lifting the peripheral ring of the suction cup 210.

Referring to FIG. 2 again, the cover cup 220 is attached to a ball joint which includes a ball 228 and a socket formed by a first part 222 and a second part 224. The first part 222 and the second part 224 are either glued or screwed together during an assembly process. The first part 222 is attached to the cover cup 220 and the ball 228 is attached to a linking rod 230 according to an embodiment of the present invention. However, a skilled artisan would realize that the ball 228 can be attached to the cover cup 220 and the socket to the linking rod 230 instead. Apparently, the second suction device 114 of FIG. 1 can be the same as the first suction device 112 shown in FIG. 2. One end of the linking rod 230 is attached the first suction device 112 as shown in FIG. 2, and the other end of the linking rod 230 is attached to the second suction device 114 (not shown). Because the ball joints on both ends of the linking rod 230 allow a certain range of movement in all directions, referring back to FIG. 1, the Smartphone 102 mounted on the first suction device 112 can have significant freedom of movement to meet a driver's need. Subsequently, the linking rod 230 can be a straight and rigid tube made of a stainless steel. The linking rod 230 can also be a telescopic tube so that its length can be easily adjusted.

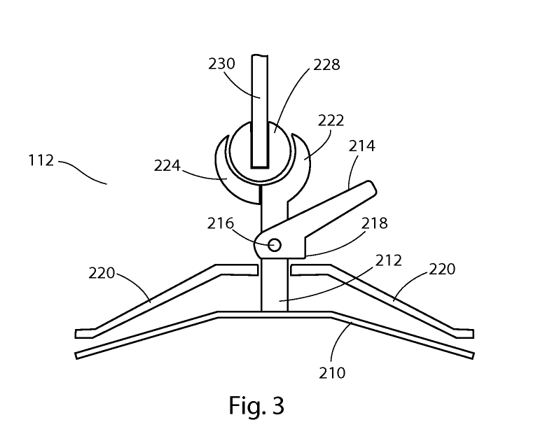

FIG. 3 is a cross-sectional view of a second implementation of the first suction device 112 for the mobile device holder of FIG. 1. A difference between the second implementation shown in FIG. 3 and the first implementation shown in FIG. 2 is that the ball joint of the second implementation is attached to the rod 212 which in turn is attached to the suction cup 210. Referring to FIG. 3, in the second implementation the first part 222 of the ball joint is attached to the rod 212.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A holder for securing a mobile electronic device with a smooth surface to a smooth surfaced object, the holder comprising:
a first suction device for being secured to a smooth surface by a suction force;
a second suction device for being secured to another smooth surface by a suction force; and
a linking member having a first end attached to the first suction device and a second end attached to the second suction device,
wherein the mobile electronic device can be secured to either one of the first or the second suction device by a suction force, while the other one of the first or the second suction device can be secured to the smooth surfaced object also by a suction force.

2. The holder of claim 1, wherein the smooth surfaced object is a windshield of a vehicle.

3. The holder of claim 1, wherein the linking member is a flexible conduit.

4. The holder of claim 1, wherein the linking member is a rigid rod.

5. The holder of claim 1, wherein the first suction device includes a suction cup made of a rubber material.

6. The holder of claim 5, wherein the first suction device includes a cover cup capable of pressing a peripheral area of the suction cup against a smooth surface.

7. The holder of claim 6, wherein the first suction device includes a first ball joint, the first ball joint having a first socket attached to the cover cup and a first ball attached to the first end of the linking member, wherein the first ball has a certain degree of freedom of movement in the first socket.

8. The holder of claim 6, wherein the first suction device includes a second ball joint, the second ball joint having a second ball attached to the cover cup and a second socket attached to the first end of the linking member, wherein the second ball has a certain degree of freedom of movement in the second socket.

9. The holder of claim 6, wherein the first suction device includes a third ball joint, the third ball joint having a third socket rigidly linked to the suction cup and a third ball attached to the first end of the linking member, wherein the third ball has a certain degree of freedom of movement in the third socket.

10. The holder of claim 6, wherein the first suction device includes a fourth ball joint, the fourth ball joint having a fourth ball rigidly linked to the suction cup and a fourth socket attached to the first end of the linking member, wherein the fourth ball has a certain degree of freedom of movement in the fourth socket.

11. A holder for securing a mobile electronic device with a smooth surface to a vehicle, the holder comprising:
a first suction device for being secured to a smooth surface by a suction force;
a second suction device for being secured to another smooth surface by a suction force; and
a rigid rod having a first end attached to the first suction device and a second end attached to the second suction device,
wherein the mobile electronic device can be secured to either one of the first or the second suction device by a suction force, while the other one of the first or the second suction device can be secured to a smooth surface in the vehicle also by a suction force.

12. The holder of claim 11, wherein the smooth surface in the vehicle is a windshield.

13. The holder of claim 11, wherein the first suction device includes a suction cup made of a rubber material.

14. The holder of claim 13, wherein the first suction device includes a cover cup capable of pressing a peripheral area of the suction cup against a smooth surface.

15. The holder of claim 14, wherein the first suction device includes a first ball joint, the first ball joint having a first socket attached to the cover cup and a first ball attached to the first end of the linking member, wherein the first ball has a certain degree of freedom of movement in the first socket.

16. The holder of claim 14, wherein the first suction device includes a second ball joint, the second ball joint having a second ball attached to the cover cup and a second socket attached to the first end of the linking member, wherein the second ball has a certain degree of freedom of movement in the second socket.

17. The holder of claim 14, wherein the first suction device includes a third ball joint, the third ball joint having a third socket rigidly linked to the suction cup and a third ball attached to the first end of the linking member, wherein the third ball has a certain degree of freedom of movement in the third socket.

18. The holder of claim 14, wherein the first suction device includes a fourth ball joint, the fourth ball joint having a fourth ball rigidly linked to the suction cup and a fourth socket attached to the first end of the linking member, wherein the fourth ball has a certain degree of freedom of movement in the fourth socket.
